(19) United States
(12) Patent Application Publication
(10) Pub. No.: US 2011/0136449 A1
(43) Pub. Date: Jun. 9, 2011

(54) Testing System and Power Calibration Method Thereof

(75) Inventor: Song-Hao Zhu, Shanghai (CN)

(73) Assignees: INVENTEC APPLIANCES (SHANGHAI) CO. LTD., Shanghai (CN); INVENTEC APPLIANCES CORP., Taipei County (TW)

(21) Appl. No.: 12/872,347

(22) Filed: Aug. 31, 2010

(30) Foreign Application Priority Data
Dec. 4, 2009 (CN) 200910253850.1

(51) Int. Cl. H04B 17/00

(52) U.S. Cl. 455/115.2

(57) ABSTRACT

The present invention relates a testing system and a power calculation method thereof. The testing system comprises a control unit and a measuring unit. The control unit is coupled to the wireless module and controls the wireless module to transmit a wireless signal with a default power value. The measuring unit is coupled to the control unit and coupled to the wireless module through a radio frequency cable. The measuring unit is controlled by the control unit for setting a measuring mode of the measuring unit, and measures the wireless signal to output a measured power value to the control unit. The control unit adjusts the default power according to the measured power value thereby compensating for power loss of the radio frequency cable.

### FIELD OF THE INVENTION

The present invention relates to a testing system, and more particularly to a testing system applicable to a wireless module.

### BACKGROUND OF THE INVENTION

At present, wireless devices are used more extensively, thereby making our life more convenient. Every wireless device, such as a wireless mouse, wireless telephone or mobile phone, usually is configured with a wireless module for transmitting wireless signals to a receiving end. For the quality control of the wireless modules, a power measuring procedure will be taken to measure whether the power of the wireless signal transmitted from the wireless module is correct or not.

Wireless signals are generally attenuated very quickly in the atmosphere, such that the measurement of radio signals in the atmosphere will be very inaccurate. Accordingly, a measuring instrument is generally installed at and coupled to a transmitting end of the wireless module through a cable. Since the attenuation rate in the cable is less than that in the atmosphere, the measured result of the attenuation rate in the cable will be more accurate. After the power loss of the wireless signals in the cable is compensated, the measured result thereof will be more accurate.

In general, a professional measuring instrument (such as a network analyzer or a power meter) is operated manually to measure the power loss of radio signals in the cable. Since the professional measuring instrument requires a complicated operation, the measuring procedure thereof is time-consuming, and requires an operator to perform the measuring procedure.

### SUMMARY OF THE INVENTION

The present invention is to provide a testing system applicable to a wireless module to automatically compensate for power loss of a radio frequency cable.

The present invention is to provide a testing system applicable to testing a wireless module. The testing system comprises a control unit and a measuring unit. The control unit is coupled to the wireless module and controls the wireless module to transmit a wireless signal with a default power value. The wireless module is a calibrated wireless module. The measuring unit is coupled to the control unit and coupled to the wireless module through a radio frequency cable. The measuring unit is controlled by the control unit for setting a measuring mode of the measuring unit, and measures the wireless signal to output a measured power value to the control unit. The control unit adjusts the default power according to the measured power value.

In an embodiment of the present invention, the control unit further adjusts the default power value according to a difference between the default power value and the measured power value.

In an embodiment of the present invention, the control unit is coupled to the wireless module through a universal asynchronous receiver/transmitter (UART) port.

In an embodiment of the present invention, the measuring unit is coupled to the control unit through a general purpose interface bus (GPIB).

The control unit is personal computer or a notebook computer.

In an embodiment of the present invention, the measuring unit is a network analyzer, a power meter or a comprehensive test instrument.

Additionally, the present invention is to provide a power calibration method applicable to a testing system coupled to a wireless module. The testing system comprises a control unit and a measuring unit. The wireless module is a calibrated wireless module, and the measuring unit is coupled to the wireless module through a radio frequency cable. The power calibration method comprises the steps as following description. A measuring mode of the measuring unit is set, and the wireless module is controlled to transmit a wireless signal with a default power value. A measured power value outputted from the measuring unit is received after measuring the wireless signal, and finally, the default power value is adjusted according to the measured power value.

In an embodiment of the present invention, the step of adjusting the default power value according to the measured power value further comprises the step of adjusting the default power value according to a difference between the default power value and the measured power value.

Based on the aforementioned description of the testing system and the power calibration method thereof in the present invention, the control unit can control the calibrated wireless module to transmit a wireless signal with a default power value. The measuring unit can receive the wireless signal through a radio frequency cable, and output a measured power value. The control unit can adjust the default power value according to a difference between the default power value and the measured power value. Therefore, the testing system can measure automatically the power loss of the radio frequency cable, and adjust the default power value according to the power loss of the radio frequency cable, thereby compensating for the poser loss of the radio frequency cable.

With these and other objects, advantages, and features of the invention that may become hereinafter apparent, the nature of the invention may be more clearly understood by reference to the detailed description of the invention, the embodiments and to the several drawings herein.

### BRIEF DESCRIPTION OF THE DRAWINGS

FIG. 1 is a block diagram of a testing system coupled to a wireless module according to an embodiment of the present invention; and

FIG. 2 is a flowchart of a power calibration method according to an embodiment of the present invention.

### DETAILED DESCRIPTION OF THE PREFERRED EMBODIMENTS

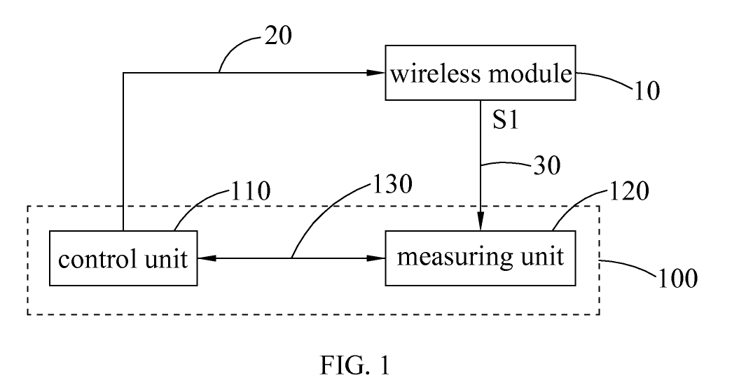

Please refer to FIG. 1, which is a block diagram of a testing system coupled to a wireless module according to an embodiment of the present invention. As shown, the testing system 100 comprises a control unit 110 and a measuring unit 120. The control unit 110 is coupled to the wireless module 10 via a circuit 20. The measuring unit 120 is coupled to the control unit 110 via another circuit 130, and coupled to the wireless module 10 through a radio frequency (RF) cable 30. In the present embodiment, the control unit 110 is, but not limited, a personal computer. In the other embodiments, the control unit 110 may be a notebook computer or electronic devices having a computer system. Moreover, the measuring unit 120 may be, but not limited, a comprehensive test instrument for the sake of cost evaluation. In the other embodiments, the measuring unit 120 may also be a network analyzer, a power meter or other electronic instruments capable of measuring wireless signals.

Additionally, in the present embodiment, the circuit 20 may be a universal asynchronous receiver/transmitter (UART) port, and the other circuit 130 may be a general purpose interface bus (GPIB). In other words, the control unit 110 can be coupled to the wireless module 10 through the UART port, and the measuring unit 120 can be coupled to the control unit 110 through the GPIB.

During the power calibration procedure, first of all, the control unit 110 is to set the measuring mode of the measuring unit 120, thereby deciding what kinds of values of electrical characteristics (such as voltage, current or power) are outputted from the measuring unit 120. The control unit 110 may transmit a command value (DAC) to a wireless module 10 for controlling wireless module 10 to transmit a wireless signal S1 with a default power value. The wireless module 10 is a calibrated wireless module, that is, the wireless module 10 uses the power value of the wireless signal S1 transmitted based on said DAC as the default power value. The wireless signal S1 is transmitted to the measuring unit 120 through the radio frequency cable 30. The wireless signal S1 is attenuated due to the electrical characteristics (such as resistive, capacitive or inductive characteristics) of the radio frequency cable 30, such that the power value of the wireless signal S1 received from measuring unit 120 is less than the default power value.

The measuring unit 120 measures the wireless signal S1, and transmits the measured voltage value, the measured current value or the measured power value to control unit 110. The assumption here is that the control unit 110 receives the measured power value to compare the measured power value with the default power value, and adjusts the default power value according to the compared result (or a difference) between the default power value and the measured power value. Furthermore, when the control unit 110 receives the measured voltage value and measured current value, the measured voltage value and measured current value are calculated by the control unit 110 to obtain the measured power value, and the control unit 110 adjusts the default power value in accordance with the difference between the default power value and the measured power value.

For example, first, the control unit 110 can set the measuring unit 120 to the measuring mode, and transmit a command value to the wireless module 10 for transmitting a 10 watt wireless signal S1. Further, the attenuated wireless signal S1 can be transmitted to the measuring unit 120, and after measuring, the measured power value is presumptively 9 watt. The control unit 110 can transmit a command value for controlling the wireless module 10 to transmit the 11 watt wireless signal thereby adjusting the power value transmitted from the wireless module 10 for compensating for power loss resulted from the radio frequency cable 30. Additionally, after calculating, a non-calculated wireless module is to be measured by the same radio frequency cable 30. The control unit 110 can transmit said another command value to control the wireless module 10 for transmitting the 11 watt wireless signal S1 thereby calculating the wireless module depending on a difference between the received measured power value and 10 watt wireless signal S1.

For another example, the assumption here is that the control unit 110 can transmit a command value to control the wireless module 10 for transmitting a 10 watt wireless signal S1. The measuring unit 120 measures the attenuated wireless signal S1 and transmits the measured power value to the control unit 110. In the meanwhile, the measured power value should be less than 10 watts, such that the control unit 110 can adjust the transmitted command value to increase the power value of the wireless signal S1. When the measured power value is closed to or equal to 10 watts, the command value has been to compensate for the power loss of the radio frequency cable 30. Further, a non-calculated wireless module is to be measured by the same radio frequency cable 30. The control unit 110 can measure the power value of the wireless module via the calculated command value to perform the calculating work of the wireless module.

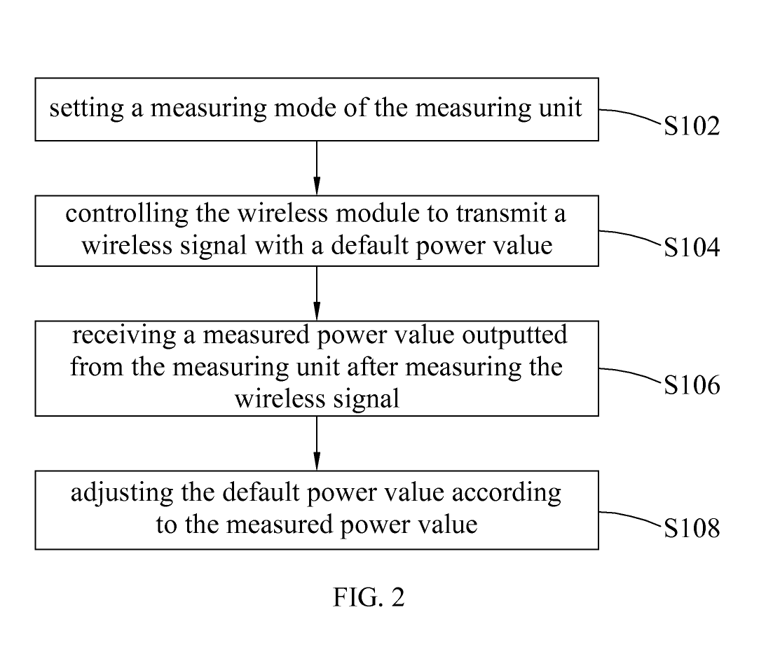

In addition, the aforementioned description can be compiled to a power calculation method applicable to a control unit 110 of testing system 100. FIG. 2 is a flowchart of a power calibration method according to an embodiment of the present invention. Please refer to FIGS. 1 and 2 at the same time, first of all, a measuring mode of a measuring unit 120 is set (in step S102), and a wireless module is controlled to transmit a wireless signal with a default power value (in step S104). Further, a measured power value outputted from the measuring unit 120 is received after measuring the wireless signal S1 (in step S106). Finally, the default power value is adjusted according to the measured power value (in step S108). The details of each step can refer to the description of the aforementioned embodiments, and are therefore not repeated herein.

It is notable that said power calculation method can be performed by a program, and be performed at a control unit 110. Therefore, a user only needs to operate a power calculation program. The control unit 110 can automatically perform a power calculation to compensate for power loss of a radio frequency cable 30 and automatically display measured values and calculated values during the calculation procedure to confirm the power calculation procedure for the user.

As set forth, in the testing system and the power calculation method according to the embodiment of the present invention, the control unit can control the wireless module to transmit a wireless signal with a default power value. The measuring unit receives the wireless signal through a radio frequency cable and outputs the measured power value, such that the control unit can adjust the default power value according to a difference between the default power value and measured power value. Therefore, the testing system can automatically measure the power loss of the radio frequency cable, and adjust the default power value in accordance with the power loss of the radio frequency cable to compensate the power loss. Furthermore, a comprehensive test instrument with lower cost can be used in the present embodiment to decrease the overall cost of the testing system. Testing personnel only need to operate a power calculation program. The control unit can automatically perform a power calculation work thereby decreasing the measuring time of the power loss of the radio frequency cable. The testing personnel do not require an operation training of measuring equipment, and thus the personnel training cost for measuring the power loss of the radio frequency cable can be decreased.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A testing system applicable to testing a wireless module, comprising:
a control unit coupled to the wireless module and controlling the wireless module to transmit a wireless signal with a default power value, wherein the wireless module is a calibrated wireless module; and
a measuring unit coupled to the wireless module through a radio frequency cable, coupled to the control unit, controlled by the control unit for setting a measuring mode of the measuring unit, and measuring the wireless signal to output a measured power value to the control unit;
wherein, the control unit adjusts the default power value according to the measured power value.

2. The testing system of claim 1, wherein the control unit further adjusts the default power value according to a difference between the default power value and the measured power value.

3. The testing system of claim 1, wherein the control unit is coupled to the wireless module through a universal asynchronous receiver/transmitter (UART) port.

4. The testing system of claim 1, wherein the measuring unit is coupled to the control unit through a general purpose interface bus (GPIB).

5. The testing system of claim 1, wherein the control unit is a personal computer or a notebook computer.

6. The testing system of claim 1, wherein the measuring unit is a network analyzer, a power meter or a comprehensive test instrument.

7. A power calibration method applicable to a testing system coupled to a wireless module, the testing system comprising a control unit and a measuring unit, the wireless module being a calibrated wireless module, the measuring unit being coupled to the wireless module through a radio frequency cable, and the power calibration method comprising:
setting a measuring mode of the measuring unit;
controlling the wireless module to transmit a wireless signal with a default power value;
receiving a measured power value outputted from the measuring unit after measuring the wireless signal; and
adjusting the default power value according to the measured power value.

8. The power calibration method of claim 7, wherein the step of adjusting the default power value according to the measured power value further comprises the step of:
adjusting the default power value according to a difference between the default power value and the measured power value.
